(19) United States
(12) Patent Application Publication
(10) Pub. No.: US 2009/0048988 A1
(43) Pub. Date: Feb. 19, 2009

(54) CUSTOMER INCENTIVE SYSTEM BASED ON AN EXTERNAL LOTTERY DRAWING

(76) Inventor: Michael Luzbet, Miami, FL (US)

Correspondence Address: FELDMANGALE, P.A., 1700 Market Street, Suite # 3130, Philadelphia, PA, 19103, US

(21) Appl. No.: 12/191,690

(22) Filed: Aug. 14, 2008

Related U.S. Application Data
(60) Provisional application No. 60/956,048, filed on Aug. 15, 2007.

(51) Int. Cl. G06Q 90/00

(52) U.S. Cl. 705/500

(57) ABSTRACT

A method of providing customer incentives to a business wherein a buyer of real and/or personal property negotiates the price of the property with the seller, and upon reaching a satisfactory price, the seller shall provide the buyer with a series of numbers prior to transferring title in the property.

### CROSS-REFERENCE TO RELATED APPLICATIONS

The present application claims priority benefit under 35 U.S.C. §119(e) of U.S. Provisional Application Ser. No. 60/956,048 filed Aug. 15, 2007, the complete disclosure of which is incorporated herein by reference in its entirety.

### FIELD OF THE INVENTION

The present invention generally relates to a method of providing a customer incentives for businesses.

### DETAILED DESCRIPTION OF THE DRAWINGS

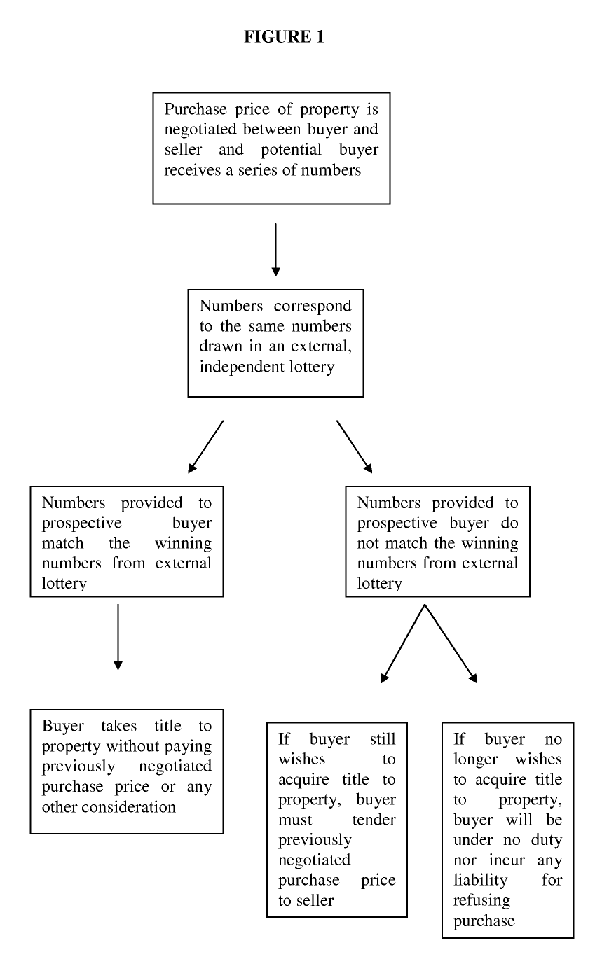

FIG. 1 depicts a flow chart of a preferred embodiment of the present invention.

### DETAILED DESCRIPTION OF THE PREFERRED EMBODIMENTS

A method of providing customer incentives to a business wherein a buyer of real and/or personal property negotiates the price of the property with the seller, and upon reaching a satisfactory price, the seller shall provide the buyer with a series of numbers prior to transferring title in the property.

Each negotiation between buyer and seller for real and/or personal property shall correspond to an external and independent lottery drawing so that if the series of numbers provided by the seller to the buyer match the same series of winning numbers randomly selected by the corresponding lottery drawing, the buyer may take title to the previously negotiated real and/or personal property without paying the negotiated purchase price or any other amount of consideration.

If the numbers randomly selected by the corresponding lottery drawing do not correspond to the numbers provided by the seller to the buyer, the buyer may only receive title to the real and/or personal property by tendering the previously negotiated purchase price to the seller.

In another embodiment, if the numbers randomly selected by the corresponding lottery drawing do not correspond to the numbers provided by the seller to the buyer, the buyer will be under no obligation to purchase the real and/or personal property, and shall incur no liability for declining to purchase to the real and/or personal property.

The following are prophetic examples of the present invention.

### EXAMPLE 1

A potential buyer approaches a used car salesman and negotiates a purchase price with the salesman for the title to a particular used car. After the buyer and seller agree on a satisfactory purchase price, the salesman provides the buyer with a series of three numbers. The three numbers can be selected randomly or, in another embodiment, the three numbers can be selected from the last three digits of the buyer's driver's license number. If the three numbers provided to the buyer by the salesman match the same three numbers selected in the Florida Lotto's™ next Cash 3™ drawing, the buyer is free to take title in the previously negotiated used car without paying the salesman the purchase price (or any other amount of consideration) for the car. If the three numbers provided to the buyer by the salesman do not match the same three numbers selected in the Florida Lotto's™ next Cash 3™ drawing, the buyer can only take title to the car by tendering the negotiated purchase price of the car to the salesman. If, however, the buyer decides not to purchase the car, the buyer shall be under no obligation, nor incur any liability for declining to purchase the car.

### EXAMPLE 2

A potential buyer approaches a residential real estate broker and/or seller and negotiates a purchase price with the broker/seller for a particular piece of residential real property. After the buyer and broker/seller agree on a satisfactory purchase price, the broker/seller provides the buyer with a series of four numbers. The four numbers can be selected randomly or, in another embodiment, the four numbers can be selected from the last four digits of the buyer's social security number. If the four numbers provided to the buyer by the broker/seller match the same four numbers selected in the Florida Lotto's™ next Play 4™ drawing, the buyer is free to take title in the previously negotiated real property without paying the broker/seller the purchase price (or any other amount of consideration) for the real property. If the four numbers provided to the buyer by the broker/seller do not match the same four numbers selected in the Florida Lotto's™ next Play 4™ drawing, the buyer can only take title to the real property by tendering the negotiated purchase price of the real property to the broker/seller. If, however, the buyer decides not to purchase the real property, the buyer shall be under no obligation, nor incur any liability for declining to purchase the real property.

1. A method of providing customer incentives to a business comprising the following steps:
negotiating the sale price of property between a buyer and a seller; and
providing the buyer with a series of numbers prior to transferring title in the property wherein said series of numbers correspond to an external lottery drawing.

2. The method of claim 1 wherein said property is personal property.

3. The method of claim 1 wherein said property is real property.

4. The method of claim 1 further comprising the step of awarding the buyer title to the previously negotiated property if said series of numbers match said corresponding, external lottery drawing.

5. The method of claim 1 further comprising the step of permitting the buyer to decline the purchase of said property if said series of numbers do not match said corresponding, external lottery drawing.
